(19) United States
(12) Patent Application Publication
(10) Pub. No.: US 2019/0023587 A1
(43) Pub. Date: Jan. 24, 2019

(54) PRODUCED WATER FILTRATION

(71) Applicant: Noles Intellectual Properties, LLC, Washington, OK (US)

(72) Inventor: Jerry W. Noles, Blanchard, OK (US)

(73) Assignee: Notes Intellectual Properties, LLC, Washington, OK (US)

(21) Appl. No.: 16/044,185

(22) Filed: Jul. 24, 2018

Related U.S. Application Data
(60) Provisional application No. 62/536,106, filed on Jul. 24, 2017.

(51) Int. Cl. C02F 1/00; C02F 1/28; B01D 15/00; B01D 24/00; B01D 24/38; B01D 24/40; B01D 24/48; B01D 24/46

(52) U.S. Cl. CPC C02F 1/008; C02F 1/004; C02F 1/281; B01D 15/00; B01D 24/007; C02F 2103/10; B01D 24/402; B01D 24/4884; B01D 24/4861; B01D 24/4631; B01D 24/383

(57) ABSTRACT

A system for treating water includes at least one pump, at least one filter pot coupled to the at least one pump and configured to pass the flow of water to be treated in a first direction, at least one valve upstream of the filter pot, and, a processor operably coupled to the at least one pump and the at least one valve. The processor is configured to implement computer executable instructions that cause the processor to perform functions that include receiving a signal reflective of the parameter from at least one sensor, generating a cleaning signal as a function of the parameter, transmitting the cleaning signal to the at least one valve to close the valve to the source of water to be cleaned, and operating a cleaning cycle in which a cleaning water is flushed through the filter pot in a second direction opposite the first direction.

### CROSS-REFERENCE TO RELATED APPLICATIONS

This application claims the benefit of and priority to U.S. Provisional Patent Application No. 62/536,106 titled “Produced Water Filtration” and filed Jul. 24, 2017, the disclosure of which is incorporated in its entirety by this reference for all purposes.

### BACKGROUND

Within recent years, the oil and gas industry has developed the use of hydraulic fracturing to produce what were once considered non-productive oil and gas formations. This hydraulic fracturing technology uses high volumes of water to be pumped into the wells, under tremendous rates and pressures, to pry the rock apart and create fractures that allow the oil and gas that is trapped within the matrix of these formations to migrate to the wellbore and up the production casing.

Although the use of this technology has allowed high volumes of oil and gas recovery from these formations, the use of these large volumes of water has been widely scrutinized. Because the water that is used during these fracturing operations is desired to be clean and free from contaminates, current technologies use fresh water sources that are normally used for irrigation and human consumption.

The use of these fresh water supplies has begun to have an impact on the availability of fresh water for human consumption and irrigation. Although the water that is pumped into these formations is recovered over the production life of the oil and gas well, the water becomes contaminated with chemicals from the fracturing process as well as minerals that are leached from the producing reservoir during the production of the well.

Most oil and gas reservoirs were created from decomposed organic matter generated from oceanic sea beds. Fresh water may mix with salt water that may be produced from the hydrocarbon formations. This may make one or both of the frac water and the formation water unsuitable for human consumption and/or reusable for hydraulic fracturing. In addition, oil from the reservoir may become micronized and entrained within the frac and/or produced water. This oil may be present in amounts as high as 5% by volume and may be problematic when filtering or cleaning the frac water and/or the water produced from the well. The frac water and/or the water that is produced or that flows back from the well may then be disposed of by pumping it into deep non-productive oil and gas formations. This cycle may be repeated for each well and may use hundreds of thousands of barrels for each operation.

This process and the possibility it might diminish fresh water supplies has generated a need for an economic technology that might clean these large volumes of frac water and/or produced water generated by the flow-back of these fluids into the well bore after the completion of a frac job and/or during the production of hydrocarbons from the well. Additionally, there may be a benefit to treating and reusing the frac water and/or produced water in subsequent frac treatments or jobs in the well at issue or in other wells instead of disposing the frac water and/or produced water. Reusing this water may reduce the burden that otherwise may be placed on fresh water supplies to prepare new frac water solutions for subsequent wells.

The industry has tried multiple technologies to clean and repurpose this water. These technologies, though, typically are unique or at least catered to a region or even the well and, consequently expensive because of the complex and wide variety of challenges that frac water and/or produced water may pose. For example, the type of contaminates, minerals, chemicals, a wide range in particle size and volume of solids, the existence of trace oil and more, often vary, perhaps significantly, between regions, fields, and even wells within the same field. The sheer variety and variability of technological challenges make it almost impossible for companies to provide an off-the-shelf solution that can be scaled and used in multiple wells and fields.

For example, reverse osmosis membrane systems or molecular filters have been used to separate these small particles from the water. These osmosis systems, however, are typically not designed to handle high levels of solids or chlorides. This may be further compounded by the nature of very small droplets of oil being entrained with in the body of the water. This oil and grease have proven to be very difficult to handle conventionally within osmosis systems and, even when modestly successful, the oils and greases may damage the membranes of the osmosis systems and risks significant degradation in the performance and potential failure of osmosis systems.

To address the challenges that contaminates pose to the membranes of osmosis systems, the frac water and/or produced water may be passed through media filters such as sand prior to the water reaching the osmosis membranes to reduce the risk that any contaminates might plug the membranes.

However, these media filters do not work well with oil, as the oil tends to stick to the sand causing it to rapidly decrease the volume of clean sand available to filter the water.

During backwash operations, i.e., pumping water backward through the media filter to remove particulates and other contaminates, the gummy oil and sand may entrain the sand and cause it to be carried out of the filter pot during the backwash cycle. This process potentially may continue, and the sand may be lost from the media filter, the sand may become partially or wholly blinded (e.g., contaminates block or occlude the pore spaces and prevent the water from flowing through the media filter), and may diminish the volume of water that the media filter might otherwise pass through the filter in an uncontaminated or clean state.

Because of this, companies have tried to incorporate the use of ceramic filters in their various filtration systems. Ceramic filters may separate a portion of the oil from the water, but they typically are incompatible with a high iron content that often may exist the produced water. The iron may cause the ceramic filters to bind and lose function over time.

Micro-filtration using polytetrafluoroethylene (PTFE) and/or polyvinylidene difluoride (PVDF) membranes and fibers have also been tried previously. These PTFE and PVDF membranes may not be as affected by any oil present in the water, but they typically are quite costly, reduce the volumetric throughput of the filters, and have a relatively short usable life, which make these membranes unattractive as a solution.

Therefore, the industry has been left with using disposable filters. These disposable filters use cloth or paper elements to pre-filter the water to remove oil present in the water before the water is then sent to the media filter. The disposable filters typically have a pore size between 50 to 100 microns and must typically be changed at a high frequency. Filters also exist with a smaller pore size, including those one micron or smaller through pores sizes suitable for micro-filtration. Filters with a pore size in the range of 1 to 5 microns, however, typically do not work well with micronized or small diameter oil and, as discussed above, the media filters that typically filter contaminates in the range of 1 to 5 microns are often not sufficiently functional in the presence of oil. Regardless of the pore size of the disposable filters, it is a known deficiency that disposable filters may be changed every hour or so, creating a very labor intense operation.

Other separation methods may use large capacity retention and settling ponds, sometimes with added polymers and/or microbes to digest and separate the solids from the water. Although this technology has worked for years in the municipal areas, it was not designed to handle the types of materials associated with water produced after fracking and/or the during the production of hydrocarbons. That combined with the large volumes that must be retained as well as the large volumetric flows that typically are processed, makes retention and settling ponds at best inefficient and quite often ineffective for this application.

Thus, there is a need for a water treatment technology that is capable of handling high volumes of liquids, typically water as its primary component, with suspended solids, such as polymers and chemicals, as well as the smaller dissolved solids such as iron, salts and other minerals. In addition, the technology should be capable of handling liquids that include entrained oil. Finally, the technology ought not require large retention reservoirs for settling of the solids.

The following embodiments describe a technology that can be effectively applied in each basin and may not be impacted or fouled by the high volumes of contaminates, including solids and hydrocarbons, that is generated by the produced water.

### BRIEF SUMMARY

A system for treating water may include at least one pump configured to be coupled to a source of water to be treated. At least one filter pot may be coupled to the at least one pump and configured to pass the flow of water to be treated in a first direction through the at least one filter pot. A media is disposed within the at least one filter pot to filter the water to be treated. At least one valve may be disposed upstream of the filter pot. A processor optionally is operably coupled to the at least one pump and the at least one valve. The system may include at least one of a skid and a trailer, wherein the at least one filter pot is coupled to the one of the skid and the trailer.

The system may further include at least a second valve downstream of the filter pot. Optionally, the at least one valve is a multiport valve coupled to the pump and to a storage tank configured to receive a cleaning water after it passes through the at least one filter pot. Similarly, the at least a second valve optionally is a multiport valve coupled to a source of cleaning water.

The system may include at least one sensor configured to detect a parameter and to transmit a signal reflective of the parameter to the processor. The at least one sensor may comprise a plurality of pressure sensors, wherein at least a first pressure sensor is positioned upstream of the at least one filter pot, and at least a second pressure sensor is positioned downstream of the at least one filter pot, wherein the at least a first pressure sensor is configured to detect a first pressure and to transmit a first pressure signal reflective of the first pressure sensor to the controller and the at least a second pressure sensor is configured to detect a second pressure and to transmit a second pressure signal reflective of the second pressure to the processor. Optionally, the at least one sensor comprises at least one flow rate sensor configured to detect a first flow rate of the water to be treated and to transmit a first flow rate signal reflective of the first flow rate to the processor, and wherein the cleaning signal is a function of the first flow rate signal.

Optionally, the processor is configured to implement computer executable instructions stored within a computer memory in communication with the processor. The computer executable instructions, when implemented by the processor, cause the processor to perform functions comprising: receive a signal reflective of the parameter from the at least one sensor; generate a cleaning signal as a function of the parameter; transmit the cleaning signal to the at least one valve to close the valve to the source of water to be cleaned; and, operate a cleaning cycle in which a cleaning water is flushed through the at least one filter pot in a second direction opposite the first direction. Optionally, the cleaning signal is a function of at least one of the first pressure signal, the second pressure signal, and a differential pressure signal that is a difference between the first pressure signal and the second pressure signal.

The system may include a first input interface, such as a video screen, monitor, smart phone, keyboard, mouse, or other input device and interface in communication with the processor and configured to receive an indication of at least one of a) a frequency of the cleaning cycle; b) a duration of the cleaning cycle; c) a minimum value of the parameter below which the processor generates the cleaning signal. The system may also include a first output interface, such as a video screen, monitor, smart phone, or other output device and interface in communication with the processor and configured to output an indication of at least one of the signal reflective of the parameter from the at least one sensor and the cleaning signal.

In another embodiment, a control system for an apparatus coupled to a source of water to be cleaned and that executes a cleaning cycle of the apparatus includes a processor configured to implement computer executable instructions; at least one sensor configured to detect a parameter and to transmit a signal reflective of the parameter to the processor; a computer memory in communication with the processor and storing computer executable instructions, that when implemented by the processor cause the processor to perform functions comprising receiving a signal reflective of the parameter from the at least one sensor, generating a cleaning signal as a function of the parameter, transmitting the cleaning signal to at least one valve to close the valve to the source of water to be cleaned, and operating a cleaning cycle in which a cleaning water is flushed through at least one filter pot in a second direction opposite to a first direction in which the water to be cleaned flows.

The functions may further include one or more singly or in combination of transmitting the cleaning signal to at least a second valve to open the valve to a source of cleaning water, generating a stop signal as a function of the parameter, transmitting the stop signal to the at least one valve to reopen the valve to the source of water to be cleaned, and operating a filter cycle in which the water to be cleaned is passed through the at least one filter pot in the first direction. The functions further may include transmitting the stop signal to the at least a second valve to close the valve to the source of cleaning water. The processor may perform any of the above noted functions, including but not limited to the function of transmitting the cleaning signal when the parameter exceeds a maximum valve and wherein the processor performs the function of transmitting the stop signal when the parameter falls below a minimum value.

Optionally, the parameter of the control system may include at least one of a flow rate, a first pressure, a second pressure, and a differential pressure across the at least one filter pot.

The processor may be located remotely from the at least one filter pot and the at least one valve and communicates wirelessly with the at least one valve.

Methods of performing a filter operation and a cleaning operation are disclosed and may include any of the components disclosed above necessary to perform the steps executed by the processor as described above, as one of skill in the art would understand.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are and will be understood by those of ordinary skill in the art to encompass obvious improvements and modifications thereto.

Additional advantages of the present invention will become readily apparent from the following discussion, particularly when taken together with the accompanying drawings.

### DESCRIPTION OF THE DRAWINGS

To further clarify the above and other advantages and features of the one or more present inventions, reference to specific embodiments thereof are illustrated in the appended drawings. The drawings depict only typical embodiments and are therefore not to be considered limiting. One or more embodiments will be described and explained with additional specificity and detail through the use of the accompanying drawings in which:

FIG. 1 illustrates an embodiment of a plurality of filter pots in series on a skid;

FIG. 2 illustrates a chart of the performance of different grades of activated filter media compared to sand for various sizes of particles at a given flow rate of 20 meter/hour;

FIG. 3 illustrates a chart of the comparative efficiencies of a backwash/cleaning process of activated filter media and sand; and,

FIG. 4 illustrates a block diagram of the system.

The drawings are not necessarily to scale.

### DETAILED DESCRIPTION

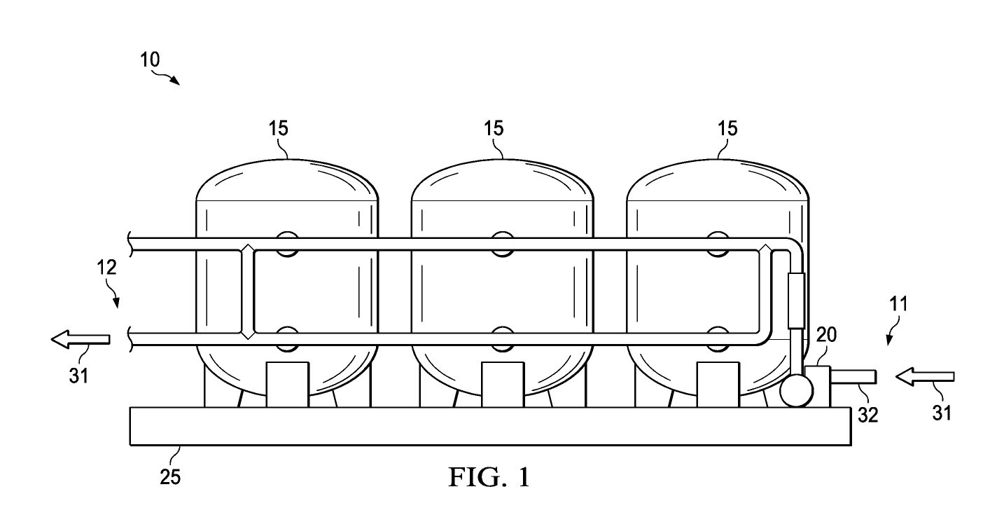

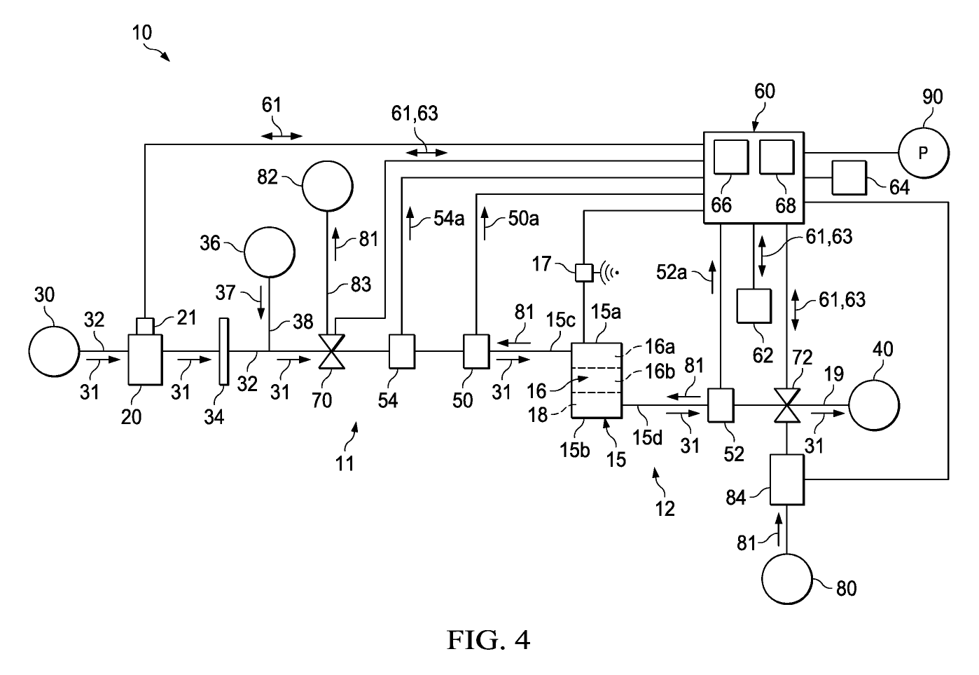

FIGS. 1 and 4 illustrate an embodiment of a water filtration system 10 that includes at least one and, in some instances, a plurality or a series of filter pots 15. FIG. 1 illustrates a plurality of filter pots 15 coupled in series, while FIG. 4 illustrates an idealized filter pot 15 alone for clarity, although FIG. 4 could certainly include a plurality of filter pots 15 in series and/or in parallel as discussed below. Optionally, the at least one filter pot may be integrated with a pump 20 on a common transport device 25, such as a skid, pallet, vehicle, trailer, or other device to make transportation of the system easy.

The water may be one or more of frack water produced during flowback after a frac job or produced water that is obtained during the production of a hydrocarbon well. The water may include one or more of any variety of contaminates, minerals, chemicals, polymers, a wide range in particle size and volume of solids, hydrocarbons (such as trace oil), salts, iron, and more. For purposes of this application, the terms water or produced water will collectively encompass all potential forms of liquid with entrained and/or dissolved contaminates from either or both the flowback of frac water and water produced from a hydrocarbon or other type of well during the production of fluids from that well. Filtered water will refer to water that has been treated by at least one of chemicals and/or passing through a filtration system.

Optionally, the water may flow from a source 30 of water to be treated, such as a well, retention pond, storage tank, or other source via one or more conduits 32, such as a pipe, tubes, hoses, and so forth. At least one screen 34 optionally may be placed ahead of the at least one filter pot 15 to pre-screen the water and to remove any larger contaminates and solids that may be present in the water. The screen 15 may be a mesh, fiber, or other screen, and may be of any suitable size and/or shape. In some embodiments a plurality of screens 15, whether in series or in parallel, may be used to pre-screen the water.

The water optionally may be treated with an oxidizer such as, but not limited to, peroxide, chlorine, or other oxidizing chemical optionally before it reaches at least one of the screens and/or the at least one filter pot. The oxidizer may be provided from a source 36 of oxidizing chemicals and may be introduced manually or automatically as indicated by flow line 37 into the water via a conduit 38, line, hopper, sprayer, sparger, or other similar manner. The chemical(s) may be in liquid or solid form (powder, pellet, and so forth). Optionally, the chemical(s) may be selected to convert iron that may be present in the water from FE2 to FE3. Oxidized contaminates optionally may then be filtered from the water either at the screens and/or the at least one filter pot and optionally removed during backwash operations.

Water traveling in a first direction 31 may be introduced to the at least one filter pot 15 and, optionally, the water may then proceed through one or more additional, or a plurality or series, of filter pots 15 until exiting the system from the at least one filter pot 15 or the ultimate filter pot 15 of the plurality of filter pots 15.

In an embodiment in FIG. 4, flow back and/or produced water may be pumped from one or more of a well, a water separator, storage reservoir, or other source of water 30 via a pump 20. The pump 20 may be of any time known, including centrifugal, piston, submersible, and other types of pumps. The pump 20 optionally is a high volume, low pressure pump. A variable frequency drive 21 may be used to control the pump 20. The variable frequency drive 21 and/or the pump 20 itself may be operably coupled to a processor or a controller 60, which may generate and/or receive a pump signal 61 and transmit the pump signal 61 to the variable frequency drive 21 or the pump 20. The processor/controller 60 may adjust the rate at which the pump 20 operates based on the type, size, and number of filter pots 15, the condition of the water to be treated, the anticipated or actual flow rate of the water, and more.

The water may then be directed into at least one filter pot 15 that optionally includes a media 16, such as sand or any other suitable filter media alone or in combination with one or more other media. Optionally, the media 16 may be, in whole or in part, an activated filter media, such as green glass media or other activated filter media. One example of an activated filter media is AFM®, which is a trademark of the Dryden Aqua Company of Edinburgh, United Kingdom, and/or another activated filter media. Regardless of the specific type, the media 16 optionally may be heat treated and surface coated to increase the surface area of the media 16, which may prevent oil and other contaminants from sticking to the surface of the media. This may allow about 100% volumetric recovery of the media 16 after conducting a backwashing operation to clean the media 16, which may reduce or eliminate any degradation or loss of the media 16.

Optionally, activated filter media replaces partially or wholly replaces sand, crushed glass, or other media as the filter media 16 in at least one filter pot, a subset of the plurality of the filter pots, or each of the plurality of filter pots. The activated filter media may have at least a 5%, at least a 10%, at least a 15%, at least a 20%, or at least a 25% lower density than crushed glass, sand, or other media as calculated by weight. For example, the activated filter media may have at least a 15% lower density than sand; thus, if a filter pot requires 200 kg of sand, the same performance may be achieved with 170 kg (or 15% less) activated filter media.

Activated filter media may be manufactured from a specific glass type. The activated filter media optionally may be processed to obtain a desired particle size and/or shape. The activated filter media may also be processed, or activated, to increase the individual (i.e., the mean or median individual particular) and/or collective surface area of the activated filter media by at least 10 times, at least 50 times, at least 100 times, at least 200 times, at least 300 times or at least 400 times as compared to the surface area of crushed glass (e.g., non-activated filter media), sand, or other filter media. Optionally, the surface area of the activated filter media may have a negative charge (zeta potential) to electro-statically attract organics and small particles. The activated filter media may also include one or more metal oxide catalysts, which may create a high reduction, or redox potential, which in turn may make the activated filter media at least partially, and in some instances fully, self-sterilizing.

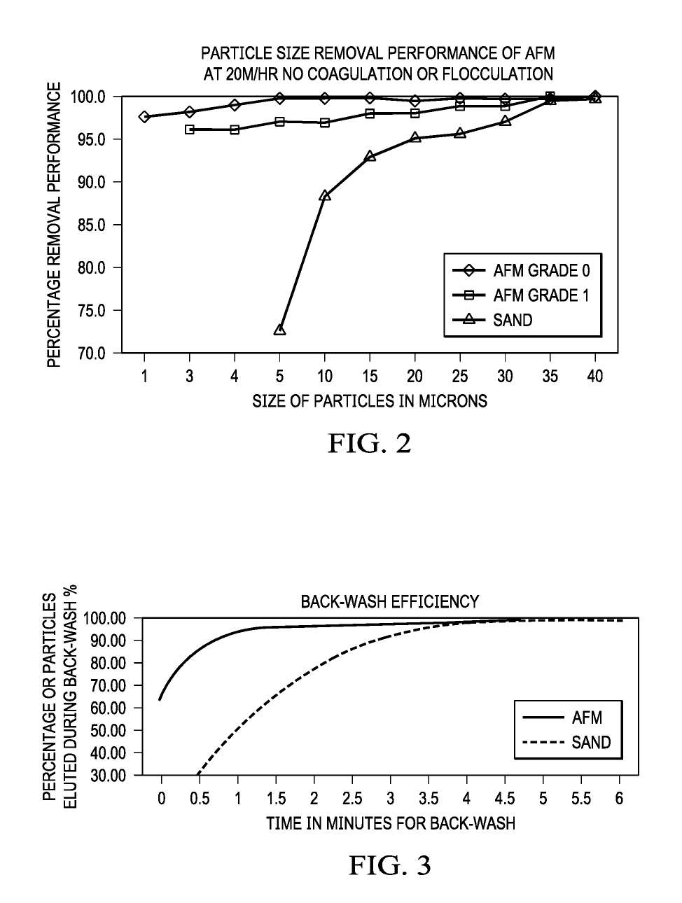

In one embodiment, green glass media 16 may be layered into a top down filter pot 15 using decreasing sizes or dimension (e.g., one or more of diameter, length, width, and/or height) of media relative to the top-to-bottom direction to prevent the larger size of media from passing through the next size of media. In other words, the largest media 16a is at the top, and the media 16 gets smaller the deeper or lower the position of the media in the filter pot 15 until the smallest media 16b is at the bottom. By doing this, the media 16 in the filter pot may filter out particles having a dimension (e.g., diameter, length, width, and/or height) in the range of about 1 micron to about 5 microns plus or minus 20%, as illustrated in FIG. 2. The natural density of the particles removed may provide different settling rates. This may allow the smallest particle to stay on the top and the largest media size to stay on the bottom.

Optionally or additionally to filter pots 15 as described in the preceding paragraph, the water may be directed through at least a plurality of filter pots 15, wherein each of the plurality of filter pots includes progressively smaller filtration media than the preceding filter pot 15.

The filter pot 15 may be capable of providing sufficient filter area to handle a volumetric flow of the pump 20. In other words, the size and volumetric throughput of the filter pot 15 may be a function of the volumetric flow rate or capacity of the pump 20.

Optionally, the plurality of filter pots 15 may be linked in a hydrologically connected series (see FIG. 1), in parallel, or in any combination of series and parallel. For example, the at least a plurality of filter pots may be disposed in parallel to allow for higher filtration rates with increased collective surface area as compared to an arrangement of the plurality of filter pots in series. The partial or wholly parallel configuration may reduce backwash frequencies while reducing the median or mean size of the individual media filter as compared to another configuration, such as series, of the plurality of filter pots 15.

The at least one filter pot 15 and/or one or more of the plurality of filter pots 15 and the various sensors (discussed below) may be operably coupled either directly or wirelessly via a transmitter/receiver 17 to the processor or controller 60 and/or to the Internet for transmission to a remote computing device (computer, tablet, smart phone, server, and so forth) to allow remote monitoring and data acquisition related to the filtering and cleaning processes.

Optionally, either within the at least one filter pot 15 and/or before or after the at least one filter pot 15, at least one bed 18 with further filtering material, such as resins, fibers, carbon, activated charcoal, and/or other material individually or in combination may be used to remove or reduce specific dissolved solids, organic molecules, odor causing substances, particulates, and the like.

Once the water passes through the system, the treated water maybe delivered via a conduit to a treated water storage system 40, such as a tank, retention pond, and retained for reuse, further treatment, or disposal or it may be delivered directly to an injection well for immediate disposal.

Optionally, the backwash or cleaning cycle (as discussed in further detail below) for each of the plurality of filter pots 15 may be independently controlled based on at least one of the flow rate of water through the given filter pot 15 and the differential pressure of the given filter pot 15.

The volumetric throughput of the filter pot 15 may be adjusted based on the size of the filter pot 15 and the amount of an aggregate surface area of the media 16 exposed to the flow of water.

In some embodiments, a backwash operation to clean the filter media 16 may occur. To perform a backwash operation, backwash water may be directed from a bottom 15b of the at least one filter pot 15 to a top 15a of the at least one filter pot 15 or from the end of the system 12 to the beginning of the system 11. An increase in the velocity of the backwash water compared to the velocity of the water being filtered may be used to back wash the at least one filter pot 15 from the bottom 15b upwards to clear any oil or contaminates that may have been removed during filtering operations. For example, the velocity of the backwash water may be 2, 3, 4, 5 or more times the velocity of the water being filtered or any range therebetween.

A first pressure sensor 50 may be positioned at or near the top 15a of the filter pot 15 and/or a second pressure sensor 52 may be positioned at or near the bottom 15b of the filter pot 15. The first and second pressure sensor 50, 52 optionally may be placed on an inlet 15c or an inlet line of the filter pot 15 and/or the outlet 15d or outlet line of the filter pot 15. The pressure sensors 50, 52 each may generate and transmit a pressure signal (first pressure signal 50a, second pressure signal 52a) representative of the respective pressure to the processor or controller 60. The controller 60 may operate a computer program or other computer executable functions to calculate a differential pressure across the media 16 and/or filter pot 15 during filtration. The controller 60 may in turn generate a differential pressure signal 61 representative of the differential pressure and/or generate a cleaning or backwash signal 63 and transmit one or both of the differential pressure signal 61 and the cleaning signal 63 to an optional output interface 62 that may be coupled to the controller 60. Optionally, the controller 60 may generate the cleaning signal 63 when at least one of the first pressure signal 50a and the second pressure signal 52a exceeds a set point input into the processor 60 or controller by a user via an input interface 64 or stored in a database or memory 66 of the controller. Alternately or additionally, an optional switch 68, such as a pressure switch or other suitable switch (manual, electro-mechanical, and so forth), may generate the cleaning signal and either send it directly to the variety of valves as discussed below or to the controller 60 to which it may be operably coupled.

Optionally, at least one device used to measure the flow rate, such as a flow rate sensor 54, may be incorporated into the system 10 and, in some embodiments, a plurality of flow rate sensors 54 may be incorporated. For example, a flow rate sensor 54 may optionally be placed upstream of the at least one filter pot 15 and/or downstream (not illustrated) from the at least one filter pot 15. The flow rate sensor 54 may generate and transmit a flow rate signal 54a representative of the volumetric and/or mass rate of flow either upstream of the at least one filter pot 15 or downstream of the at least one filter pot 15, as the case may be, and transmit the flow rate signal 54a representative of the flow rate to the controller 60. The controller 60 may operate a computer program or other computer executable functions to calculate an actual flow rate based on the flow rate signals from one or more flow rate sensors positioned on either side/across the filter media 16 and/or the filter pot 15 during filtration and/or compare the flow rate downstream of the filter pot 15 compared to an expected flow rate, wherein the expected flow rate is determined via a database or table, manually entered, or determined from the flow rate measured at the first or upstream flow rate sensor. The controller 60 may in turn generate a cleaning or backwash signal 63, which may be a function of the flow rate, and transmit the cleaning signal 63 to the optional output interface 62 that may be coupled to the controller 60 and/or to the valves as discussed below.

As discussed, the frequency at which a cleaning or backwash operation occurs may be a function of a selected parameter, which parameter may include one or more of the mass and/or volumetric flow through the system 10 or at least through at least one filter pot 15 and/or a function of the pressure or differential pressure through the system 10 or at least through the at least one filter pot 15, as measured by the at least one flow rate sensor 50 and/or the at least one pressure sensor 50, 52, or another parameter.

As noted the processor/controller 60 may monitor and control the filtering process as well as the cleaning/backwash process. The controller 60 may be operably coupled to a first valve 70 upstream of the at least one filter pot 15, or at any point upstream of the screens 34 and inlets for any oxidizers 36. The controller 60 may also be coupled to a second valve 72 downstream of the at least one filter pot 15. The first valve 70 and the second valve 72 optionally may include a plurality of valves to accommodate a system 10 that includes a plurality of filter pots 15 in series or in parallel so as to isolate each of the filter pots 15 individually, and/or by a selected grouping of filter pots 15 (e.g., two filter pots, three filter pots, etc.), and/or by the segment of the parallel train the plurality of filter pots 15 are positioned. The first valve 70 and the second valve 72 may be of any suitable type including manual (in those instances in which the controller 60 directs a cleaning signal to an output interface 62 to prompt a user to manually operate the valves 70, 72 and perform a cleaning process), hydraulic, electro-mechanical, gas operated, pneumatic operated, and other types of valves. Optionally, one or both of the first valve 70 and the second valve 72 may be a multiport valve in which the flow optionally may be stopped completely and/or redirected to two or more different locations, either fully or partially diverting the flow between the two or more different locations.

The first valve 70 and the second valve 72 each optionally may include an actuator or switch integral within the respective valve or coupled to the respective valve. The switch, in turn, may be operably coupled to the controller 60 and configured to be actuated when the controller 60 transmits the cleaning signal 63 to the switch.

The first valve 70 and the second valve 72, when actuated by the controller 60, may then halt or redirect the flow of untreated water from the top of the filter pot 15 and initiate the flow 81 of cleaning water or cleaning solution (which may include a water as a portion of the solution) from a source 80, such as tank, retention pond, well, utility/water line and so forth, of the cleaning water coupled to at least one of the first valve 70 and, more typically, the second valve 72 via a tube, pipe, hose, or other conduit. Another pump 84 optionally may be coupled to the source 80 of the cleaning water or, alternatively, the first pump 20 may be coupled via the valve 70,72 between both the source 30 of water to be treated and the source 80 of cleaning water. Regardless, the another pump 84 may optionally be of any of the types and have any of the features of the pump 20 described above.

The cleaning or backwash water is flushed through the system 10 and through the at least one filter pot 15. After exiting the filter pot near the top 15a of the filter pot 15, the cleaning water may then be directed through the first valve 70 or another valve via a conduit 83 to a storage device 82, such as a storage tank, retention pond, or other manner of holding the cleaning water for later treatment and/or disposal. For example, the storage device 82 may be any suitable tank, such as a flush tank.

The controller 60 may operate the cleaning process as a function of time, whether programmed or entered into the input interface 64 by a user and stored in the computer memory 66, and/or the cleaning cycle may persist for a period of time as a function of one or more of the first pressure measured at the first pressure sensor 50, the second pressure measured at the second pressure sensor 52, the differential pressure, the flow rate measured at one or more flow rate sensors 54 or other parameters similar to those for generating a cleaning signal 63 as discussed above.

Optionally, one or more of the controller 60, valves 70, 72, sensors 50, 52, 54, and first and/or second pump 20, 82 may be operably coupled to a power source 90 either directly or indirectly (typically via the controller). The power source 90 may be of any type, such as alternating current (AC, such as from grid power), direct current (DC, such as from batteries), solar power, power from a generator (whether provided separately with fuel or operating from produced hydrocarbons) and so forth.

The one or more present inventions, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system for treating water, the system comprising:
at least one pump configured to be coupled to a source of water to be treated;
at least one filter pot coupled to the at least one pump and configured to pass the flow of water to be treated in a first direction through the at least one filter pot;
a media disposed within the at least one filter pot;
at least one valve upstream of the filter pot; and,
a processor operably coupled to the at least one pump and the at least one valve.

2. The system of claim 1, further comprising at least one of a skid and a trailer, wherein the at least one filter pot is coupled to the one of the skid and the trailer.

3. The system of claim 1, further comprising at least a second valve downstream of the filter pot.

4. The system of claim 1, wherein the at least one valve is a multiport valve coupled to the pump and to a storage tank configured to receive a cleaning water after it passes through the at least one filter pot.

5. The system of claim 3, wherein the at least a second valve is a multiport valve coupled to a source of cleaning water.

6. The system of claim 1, further comprising at least one sensor configured to detect a parameter and to transmit a signal reflective of the parameter to the processor.

7. The system of claim 6, wherein the processor is configured to implement computer executable instructions, the system further comprising:
a computer memory in communication with the processor and storing computer executable instructions, that when implemented by the processor cause the processor to perform functions comprising:
receive a signal reflective of the parameter from the at least one sensor;
generate a cleaning signal as a function of the parameter;
transmit the cleaning signal to the at least one valve to close the valve to the source of water to be cleaned; and,
operate a cleaning cycle in which a cleaning water is flushed through the at least one filter pot in a second direction opposite the first direction.

8. The system of claim 6, further comprising a first input interface in communication with the processor and configured to receive an indication of at least one of a) a frequency of the cleaning cycle; b) a duration of the cleaning cycle; c) a minimum value of the parameter below which the processor generates the cleaning signal.

9. The system of claim 6, further comprising a first output interface in communication with the processor and configured to output an indication of at least one of the signal reflective of the parameter from the at least one sensor and the cleaning signal.

10. The system of claim 6, wherein the at least one sensor comprises a plurality of pressure sensors, wherein at least a first pressure sensor is positioned upstream of the at least one filter pot, and at least a second pressure sensor is positioned downstream of the at least one filter pot, wherein the at least a first pressure sensor is configured to detect a first pressure and to transmit a first pressure signal reflective of the first pressure sensor to the controller and the at least a second pressure sensor is configured to detect a second pressure and to transmit a second pressure signal reflective of the second pressure to the processor.

11. The system of claim 10, wherein the cleaning signal is a function of at least one of the first pressure signal, the second pressure signal, and a differential pressure signal that is a difference between the first pressure signal and the second pressure signal.

12. The system of claim 6, wherein the at least one sensor comprises at least one flow rate sensor configured to detect a first flow rate of the water to be treated and to transmit a first flow rate signal reflective of the first flow rate to the processor, and wherein the cleaning signal is a function of the first flow rate signal.

13. A control system for an apparatus coupled to a source of water to be cleaned and that executes a cleaning cycle of the apparatus, the control system comprising:
a processor configured to implement computer executable instructions;
at least one sensor configured to detect a parameter and to transmit a signal reflective of the parameter to the processor;
a computer memory in communication with the processor and storing computer executable instructions, that when implemented by the processor cause the processor to perform functions comprising:
receive a signal reflective of the parameter from the at least one sensor;
generate a cleaning signal as a function of the parameter;
transmit the cleaning signal to at least one valve to close the valve to the source of water to be cleaned; and,
operate a cleaning cycle in which a cleaning water is flushed through at least one filter pot in a second direction opposite to a first direction in which the water to be cleaned flows.

14. The control system of claim 13, wherein the functions further comprise:
transmit the cleaning signal to at least a second valve to open the valve to a source of cleaning water.

15. The control system of claim 13, wherein the parameter is at least one of a flow rate, a first pressure, a second pressure, and a differential pressure across the at least one filter pot.

16. The control system of claim 13, wherein the processor is located remotely from the at least one filter pot and the at least one valve and communicates wirelessly with the at least one valve.

17. The control system of claim 11, wherein the functions further comprise:
generate a stop signal as a function of the parameter;
transmit the stop signal to the at least one valve to reopen the valve to the source of water to be cleaned; and,
operate a filter cycle in which the water to be cleaned is passed through the at least one filter pot in the first direction.

18. The control system of claim 17, wherein the functions further comprise:
transmit the stop signal to the at least a second valve to close the valve to the source of cleaning water.

19. The control system of claim 17, wherein the parameter is at least one of a flow rate, a first pressure, a second pressure, and a differential pressure.

20. The control system of claim 17 wherein processor performs the function of transmit the cleaning signal when the parameter exceeds a maximum valve and wherein the processor performs the function of transmit the stop signal when the parameter falls below a minimum value.
